(19) United States
(12) Patent Application Publication
(10) Pub. No.: US 2025/0270088 A1
(43) Pub. Date: Aug. 28, 2025

(54) Process for Enhancing Production of Biofuels from Biomass

(71) Applicant: Expander Energy Inc., Calgary (CA)

(72) Inventors: Steve Kresnyak, Calgary (CA); Seyedamin Mirhadi, Calgary (CA); Hendrik Paul, Calgary (CA)

(73) Assignee: Expander Energy Inc., Calgary, AB (CA)

(21) Appl. No.: 18/858,140

(22) PCT Filed: Apr. 11, 2023
(86) PCT No.: PCT/CA2023/050494

§ 371 Date: Oct. 18, 2024

Related U.S. Application Data
(60) Provisional application No. 63/333,707, filed on Apr. 22, 2022.

(51) Int. Cl. C01B 3/34

(52) U.S. Cl. CPC C01B 3/34; C01B 2203/0216; C01B 2203/0475; C01B 2203/062; C01B 2203/148

(57) ABSTRACT

A process for enhancing production of synthetic biofuels from biomass feedstock is provided. The process involves generating a hydrogen lean syngas by gasifying a biomass and reacting the syngas in a FT reactor to produce FT vapours and FT liquids. The FT vapours are separated from the FT liquids and divided into a FT recycle stream and a tail gas stream. The tail gas stream is compressed to form a high pressure tail gas stream for reforming to generate a hydrogen rich syngas gas stream to be mixed with the hydrogen lean syngas stream, and the liquid hydrocarbons are upgraded to obtain the biofuel(s). The process further comprises removing at least a portion of the CO2 from the tail gas stream to form a modified tail gas stream, which is compressed before reforming, and/or from the hydrogen rich syngas prior to adding same the hydrogen lean syngas feed stream.

### FIELD OF THE INVENTION

The present invention pertains to the field of the production of synthetic biofuels from biomass.

### BACKGROUND OF THE INVENTION

Synthetic paraffinic fuels are well established as clean burning diesel and jet fuels with high cetane content, zero sulfur and low aromatics. These clean fuels are high-performance fuels and generally meet and exceed all the fuel market specifications as direct replacement for conventional refined fuels or as blend stock to enhance the performance of low quality conventional refined fuels. These fuels are fully compatible with conventional refined fuels and there is no limit to the quantity of paraffinic fuels that can be blended with conventional refined fuels.

These clean fuels are produced by common processes such as Gas-to-Liquids (GTL), Biomass-to-Liquids (BTL) and combined Biomass/Gas-to-Liquids (BGTL). The fuels produced by these processes use various quantities of fossil fuel feeds, and are encountering challenges to increase the renewable carbon content to meet future low carbon fuel standards. Future liquid fuels must achieve low Carbon Intensity (CI=gCO₂ₑ/MJ fuel energy) which would become less than 75 gCO₂ₑ/MJ by 2030 and less than 50 gCO₂ₑ/MJ in future years.

Current ULS Diesel refined from crude oil, have a Carbon Intensity of 95 to 120 gCO₂ₑ/MJ depending on the type of processes used, the efficiency of the refinery, the carbon intensity of the production of the crude oil and the electric power source. Regardless of the source feedstock for the production of the fuels, if the source is non-renewable or fossil based, the product fuels would have a Carbon Intensity of 65 to 70 gCO₂ₑ/MJ related only to the burning of the fuel.

Therefore, there is a need for a fossil-free biogenic process to produce low carbon clean green fuels that can obviate the limitations of the current fossil fuels and biofuels.

Biogenic fuels/biofuels that are derived from renewable biomass are viable alternatives to fossil fuels. Biogenic fuels have a carbon intensity of 0 gCO₂ₑ/MJ related to the burning of the fuel, resulting in the overall Carbon Intensity of the biofuels being in the range of 40 to 60 gCO₂ₑ/MJ, depending on the carbon footprint of the processing and sourcing of the biogenic feedstock. However, biofuels, depending on the source of feedstock, such as animal fat or recycled oils, vegetable or seed-based oils, have some less desirable properties which limit their performance and compatibility with conventional refined fuels. Biofuels require an additional hydro-processing step to resolve these issues. These types of fuels also face challenges related to competition and utilization of lands for food crops for fuel production.

The conventional BTL process using renewable feedstocks such as forestry waste wood, commercial waste wood and municipal solid wastes can achieve low Carbon Intensity (CI<40 gCO₂ₑ/MJ). However, the conventional BTL process produces hydrogen lean syngas (having H₂:CO molar ratio about 0.8 to 1.1) and requires the use of a Water-Gas-Shift (WGS) reaction or the addition of an external hydrogen source from a SMR or ATR to achieve the required H₂:CO=2.0 for a Fischer Troscph (FT) process to convert the syngas into synthetic paraffinic fuels (such as synthetic diesel, naphtha, kerosene, aviation or jet fuel and paraffinic wax, etc.). The conventional BTL process has proven to have economic challenges due to the high capital investment for the low production capabilities.

Moreover, secondary reactions occurring during biomass gasification, reforming in the SMR, and in FT synthesis can create higher levels of CO₂ concentration in the final syngas. Typical reactions may include:

| | | |
|---|---|---|
| SMR and FT Reactions | CO + H₂O = CO₂ + H₂ | (R1) WGS Reaction |
| SMR Reaction | CH4 + 2H₂O = CO₂ + 4H₂ | (R2) |
| Biomass Gasifier | CO + H₂O = CO₂ + H₂ | (R3) |
| | C + O₂ = CO₂ | (R4) Combustion Reaction |
| | CO + ½ O₂ = CO₂ | (R5) |

Concentrated levels of CO₂ build in the Fischer Troscph (FT) recycle stream, which requires increased purge rates to stabilize a desired CO₂ concentration. Without sufficient purge rates, the FT recycle stream contains depleted levels of hydrogen and carbon monoxide and increased levels of CO₂ and methane (CH₄). Increased purge rates to reduce CO₂, also results in higher losses of valuable H₂, CO and CH₄ components, which results in reduction in FT products.

Accordingly, there is an urgent need for an economic Biomass to Liquids (BTL) process that uses renewable biomass to produce a 100% biogenic, fossil-free fuel, meeting all engine fuel properties, meeting or exceeding all current and future Low Carbon Fuel Standards (LCFS) and being fully compatible with current refined fuels for blending.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a process for production of synthetic biofuels from biomass.

In accordance with an aspect of the present invention, there is provided a process for enhanced production of biofuel(s) from a biomass feedstock. The process comprises: a) gasifying a biomass feedstock under partial oxidation reaction conditions to generate hydrogen lean syngas stream comprising H₂, CO, CO₂, CH₄, and inert gases; b) treating and cooling the hydrogen lean syngas stream to form a syngas feed stream comprising H₂, CO, CO₂, CH₄ and the inert gases and feeding the syngas feed stream to a Fischer Tropsch (FT) reactor, wherein a portion of H₂ and CO react to produce liquid hydrocarbons and FT vapours, wherein the FT vapours comprise unreacted portion of H₂ and CO in the FT reactor, and non-reactive CO₂, CH₄ and inert gases in the FT reactor; c) separating the FT vapours from the liquid hydrocarbons; d) dividing the FT vapours into a FT recycle stream and a tail gas stream; e) compressing the FT recycle stream to form a high pressure FT recycle stream and mixing same with the syngas feed stream to form a concentrated syngas feed stream to enhance the FT reaction; and f) compressing the tail gas stream to form a high pressure tail gas stream and subjecting the high pressure tail gas stream to a reforming reaction to generate a hydrogen rich reformer-syngas gas stream and adding same to the syngas feed steam to form an enhanced syngas feed stream, and g) upgrading the liquid hydrocarbons to obtain the biofuel(s).

In accordance with the present invention, the process further comprises removing at least a portion of the CO₂:
i) from the tail gas stream prior to the compressing step to form a modified tail gas stream and compressing the modified tail gas stream to obtain the a high pressure tail gas stream, and removing a purge stream from the depleted tail gas stream to circumvent build-up of non-reactive inert gases,
ii) from the hydrogen rich syngas prior to adding to the hydrogen lean syngas feed stream;
iii) from the enhanced syngas feed stream, the concentrated syngas stream or both;
iv) from the FT vapours prior to being divided into the FT recycle stream and the tail gas stream;
v) from the FT recycle stream, high pressure FT recycle stream, or both; or
vi) a combination thereof.

### BRIEF DESCRIPTION OF THE FIGURES

The invention will now be described by way of an exemplary embodiment with reference to the accompanying simplified, flow diagrams. In the drawings:

FIG. 1 is a schematic drawing depicting the BTL process of prior art using WGS and hydrogen addition to lean bio-syngas for biosynthetic fuel production.

FIG. 2 is a schematic drawing depicting the process in accordance with an embodiment of the present invention for production of low carbon intensity fossil free bio-synthetic fuel.

FIG. 3 is a schematic drawing depicting the process in accordance with an embodiment of the present invention for production of combined low carbon intensity fossil/bio synthetic fuel production.

FIG. 4 is a schematic drawing depicting the process in accordance with an embodiment of the present invention for production of combined fossil/bio synthetic fuel production and co-generation of low carbon intensity hydrogen.

FIG. 5 is a schematic drawing depicting the processing accordance with an embodiment of the present invention for production of single low carbon intensity fossil free bio-synthetic diesel fuel.

### DETAILED DESCRIPTION OF THE INVENTION

Unless defined otherwise, all technical and scientific terms used herein have the same meaning as commonly understood by one of ordinary skill in the art to which this invention belongs.

As used herein, the term “syngas” is an abbreviation for “synthesis gas”, which is a gaseous mixture primarily comprising H₂ and CO, with lesser amounts of CO₂, CH₄, and inert gases.

As used herein, the term “hydrogen lean syngas” refers to syngas having H₂:CO molar ratio of about 1:1, such as 0.5:1 to 1.2:1.

As used herein, the term “hydrogen rich syngas” refers to syngas having H₂:CO molar ratio of about 2:1, such as 1.8:1 to 2.2:1, which is desired optimum ratio for use in Fischer-Tropsch reaction.

As used herein, the term “enhanced hydrogen syngas” refers to syngas having H₂:CO molar ratio of greater than 2.2:1, which is typically produced by reforming reactions, such as SMR and ATR processes.

As used herein, the term “biomass” refers to a plant-based material, such as wood waste, forestry waste material, agricultural by-products, harvested fibrous material, crops such as switchgrass, cattails, and short rotation crops, agricultural waste (crop residues, livestock by-products, etc.), industrial fibrous material, municipal waste, waste water biomass, municipal sludge, sewage biomass, or any mixture thereof.

As used herein, the terms “refinery gas” or “off-gas” refers to a gaseous mixture primarily comprising unconverted and non-condensable gases such as CO, CO₂, H₂, methane, nitrogen, argon, and lower hydrocarbons remaining after processing of the syngas and/or upgrading of liquid hydrocarbon into desired bio-fuel(s).

As used herein, the term “flash gas” refers to a spontaneous vapor that is produced during treatment operations such as CO₂ removal processes.

As used herein, the term “FT vapours” refers to a vapour stream recovered from FT unit operations, which may contain H₂, CO, CO₂, hydrocarbons, water, and/or inert gases such as nitrogen and argon.

As used herein, the term “about” refers to a +/−10% variation from the nominal value. It is to be understood that such a variation is always included in a given value provided herein, whether or not it is specifically referred to.

The present invention relates to a process for enhancing production of synthetic fuels (i.e. biofuels) from biomass.

The present invention provides an economic and Enhanced Biomass to Liquids (EBTL®) process that uses renewable biomass to produce a 100% biogenic, fossil-free biofuel, which is fully compatible with conventional fossil fuels, and can meet or exceed all current and future Low Carbon Fuel Standards (LCFS) for use in conventional transportation equipment, including automobiles, buses, trucks, trains, planes, marine vessels, off-road construction equipment, electric generators, etc. The biofuel obtained from the present process can achieve a Carbon Intensity (CI) less than 40 gCO₂ₑ/MJ without the use of carbon sequestration. With Carbon Sequestration, the present process could achieve a carbon intensity (CI) less than 0 gCO₂ₑ/MJ, which could remove an additional amount of CO₂ from the atmosphere. In one embodiment the present process could achieve a carbon intensity (CI) less than −40 gCO₂ₑ/MJ.

The synthetic fuels derived from GTL Process are challenged as they use natural gas as feed stock. Therefore, a typical GTL plant will generate fossil based clean fuel with carbon intensities equal to or greater than conventional refined fuels. Incorporation of the process of the present invention in a BGTL process would improve on the CI by introducing biogenic feedstock and lower the CI of the fuel processing and the CI for the blended fuel.

The process of the present invention involves a unique combination of unit operations/steps, including strategic removal of excessive CO₂ at one or more locations in the BTL process that would lead to increased biofuel production with reduced carbon intensity. For example, CO₂ removal from a tail-gas recycle stream comprising FT vapours; a hydrogen-rich reformer-syngas stream; a FT recycle stream comprising FT vapours (before and/or after compression); and/or a concentrated syngas stream obtained by combining syngas feed stream and tail gas recycle stream and/or FT recycle stream.

The process of the present invention comprises gasifying a biomass feedstock under partial oxidation reaction conditions to generate hydrogen lean syngas stream comprising H₂, CO, CO₂, CH₄, and inert gases. The lean syngas stream is treated and cooled to form a syngas feed stream comprising H₂, CO, CO₂, CH₄ and the inert gases, which is fed to a Fischer Tropsch (FT) reactor. In the FT reactor, a portion of H₂ and CO react to produce liquid hydrocarbons and FT vapours. The process further involves separating the FT vapours from the liquid hydrocarbons; dividing the FT vapours into a FT recycle stream and a tail gas stream; compressing the FT recycle stream to form a high pressure FT recycle stream and mixing same with the syngas feed stream to form a concentrated syngas feed stream to enhance the FT reaction. The tail gas stream is compressed to form a high pressure tail gas stream, which is subjected to a reforming reaction to generate a hydrogen rich reformer-syngas gas stream. The hydrogen rich reformer-syngas gas stream is then added to the syngas feed steam to form an enhanced syngas feed stream, and the liquid hydrocarbons are upgraded to obtain the biofuel(s).

The process further comprises removing at least a portion of the CO₂: i) from the tail gas stream prior to the compressing step to form a modified tail gas stream and compressing the modified tail gas stream to obtain the a high pressure tail gas stream, and removing a purge stream from the depleted tail gas stream to circumvent build-up of non-reactive inert gases, ii) from the hydrogen rich syngas prior to adding to the hydrogen lean syngas feed stream; iii) from the enhanced syngas feed stream, the concentrated syngas stream or both; iv) from the FT vapours prior to being divided into the FT recycle stream and the tail gas stream; v) from the FT recycle stream, high pressure FT recycle stream, or both; or vi) a combination thereof.

In some embodiments, the process comprises removing CO₂ from: the FT vapours in the tail gas stream prior to compressing the tail gas stream, to form a CO₂ depleted tail gas stream, and/or the hydrogen rich reformer-syngas prior to being added to the hydrogen lean syngas stream.

Removal of excessive CO₂ from the tail-gas recycle stream forms a modified tail-gas stream, which contains all biogenic compounds, containing concentrated levels of H₂, CO and CH₄. The modified tail-gas stream is ideally suited for conversion in a reformer (i.e. SMR) to produce new bio-syngas/reformer-syngas. The biogenic purge stream and FT upgrader off-gas stream is used as fuel for the SMR. Additional natural gas may be used as fuel without directly impacting the carbon footprint of the biofuel. In the present process, the natural gas, fossil fuel is not in direct contact with the bio-syngas that produces the biosynthetic fuel. The amount of CO₂ removal from the tail-gas stream can be optimized to reduce the purge rate and increase the amount of syngas product and subsequently increase the total biosynthetic fuel produced.

A preferred location for the CO₂ removal is the tail-gas stream for the following reasons:
i) maximizes carbon efficiency by recycling CH₄ produced in biomass gasifier and FT process, to maximize production of CO
ii) highest S/C ratio to SMR and lowest natural gas rate, resulting in the lowest CI value for the biofuel
iii) highest concentration of CO₂ to CO₂ Removal unit
iv) lowest concentration of CO to reduce degradation of the solvent
v) ideal processing conditions such as 200 to 300 psig at 80 to 120 F
vi) smallest volume to treat, requiring smallest CO₂ removal unit and SMR unit with lowest energy demand
vii) low heavy hydrocarbon concentration reducing risk of solvent foaming.

Removal of CO₂ from the SMR syngas stream or the FT reactor feed stream where the SMR syngas stream and biosyngas streams are combined, has strategic benefits in that there is no significant hydrocarbon in this stream other than methane (CH₄). This will eliminate any impacts related to absorption of hydrocarbons into the CO₂ solvent causing process upsets.

Removal of CO₂ from a FT recycle stream comprising FT vapours (before and/or after compression); and/or a concentrated syngas stream obtained by combining syngas feed stream and tail gas recycle stream and/or FT recycle stream, may have certain limitations, but can achieve similar production results.

The process of the present invention, regardless of specific location of CO₂ removal, produces a stream of concentrated biogenic CO₂ (greater than 99% purity) for carbon utilization or sequestration. In addition to the process producing a sustainable liquid biofuel with very low CI, the process will result in a negative CI, as the recovered and sequestered biogenic CO₂ is being removed from the atmosphere contributing to an overall lowering of greenhouse gases in the atmosphere.

The CO₂ removal can be achieved by any suitable process unit known to those skilled in the art, examples being chemical absorption units using solvents such as amine (MEA, DEA, MDEA, Selective (a)MDEA, Flexsorb™, Ucarsol™) or physical absorption units using solvents such as Selexol and Rectisol™. Preferably, the solvent for the CO₂ removal unit is activated (a) MDEA or any other state of the art CO₂ selective solvent.

In some embodiments, the CO₂ is removed via a chemical absorption unit selected from an Amine unit, Flexsorb™ and Ucarsol™, or via a physical absorption unit, such as Selexol or Rectisol®.

In some embodiments, the treating of the hydrogen lean syngas stream comprises filtration, tar removal, sulphur removal, cooling, compression and/or heat recovery.

In some embodiments, the reforming reaction comprises steam methane reforming.

In some embodiments, the process further comprises adding natural gas and/or natural gas liquids to the high pressure tail gas stream being directed to the reforming reaction.

In some embodiments, the process further comprises adding water and/or steam to the high pressure tail gas stream and manipulating steam to carbon ratio to exceed the H₂:CO moral ratio in the syngas gas being fed to the FT reactor.

In some embodiments, the process further comprises cooling the tail gas stream before or after the CO₂ removal step to remove at least a portion of olefins generated in the FT reactor.

In some embodiments, the process further comprises recycling at least a portion of the hydrogen lean syngas to the high-pressure tail gas stream, the modified tail-gas stream or the tail gas stream to dilute concentration of olefins in the stream being fed to the reforming reaction.

In some embodiments, the biofuel comprises naphtha and wax, and the process further comprises recycling at least a portion of the naphtha and/or wax to the high pressure tail gas stream being directed to the reforming reaction.

In some embodiments, the process further comprises directing CO₂ removed from the tail gas stream for carbon utilization and/or sequestration.

In some embodiments, the process further comprises using off/refinery-gas generated in the upgrading step as fuel in the reforming reaction. In some embodiments, the process further comprises adding the purge stream to the off gas.

In some embodiments, the process further comprises feeding at least a portion of the hydrogen rich reformer-syngas to a hydrogen separation unit to obtain high purity hydrogen stream.

In some embodiments, the process further comprises recycling at least a portion of excess heat and/or steam from the biomass gasifier to generate electrical power and/or heat energy.

In some embodiments, the process further comprises comprising feeding at least a portion of steam generated in step b) to generate electrical power and/or heat energy.

In some embodiments, the process further comprises feeding at least a portion of steam generated in the reforming of the high pressure tail gas stream to generate electrical power and/or heat energy. In some embodiments, the heat energy is used in CO₂ removal.

In some embodiments, the process comprises removing excess moisture from the biomass feedstock to achieve a desired water content level prior to feeding the feedstock to the gasifier. Excess moisture from the biomass feedstock can be removed by subjecting the initial feedstock to a biomass dryer.

The Fischer-Tropsch (FT) reaction and biomass gasification reaction are exothermic reactions. The SMR reaction requires external heat and further is equipped with waste heat recovery technologies to generate energy/heat. At least a portion of energy/heat from these reactions, typically in the form of steam or heat medium, is used to remove excess moisture from the biomass feedstock.

In some embodiments, the process comprises feeding at least a portion of the steam generated during these reactions to recover heat, which is then used to remove excess moisture from the biomass feedstock, used as process energy such as the CO2 Unit reboiler and used to produce electric power for the plant operations. Excess heat energy and/or electric power can be exported for external market use.

In some embodiments, the biogenic refinery gas from the FT reactor and upgrader is recycled to the biomass dryer for removing excess moisture from the biomass feedstock and used as SMR fuel.

To gain a better understanding of the invention described herein, the following examples are set forth with reference to the accompanying figures, which are schematic and are not intended to be drawn to scale. It will be understood that these examples are intended to describe illustrative embodiments of the invention and are not intended to limit the scope of the invention in any way.

### EXAMPLES

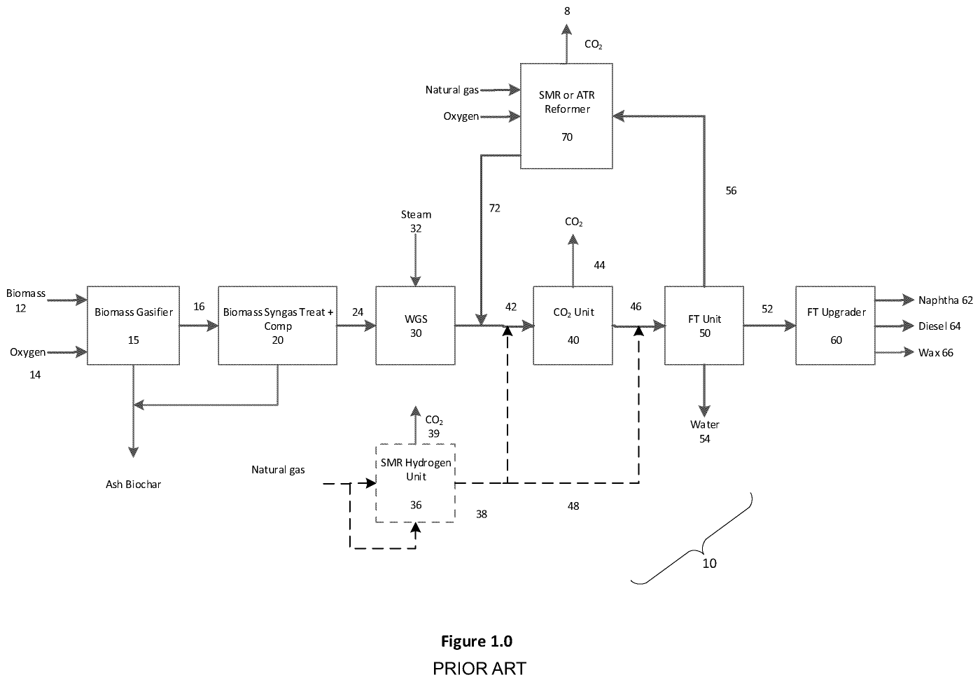

Referring to FIG. 1, which depicts a process flow diagram of a prior art gasifying biomass. The process is generally denoted by numeral 10, and begins with treating a biomass feedstock 12 in a gasifier 15 to which an oxidant such as oxygen 14 is added as required to generate a synthesis gas (bio-syngas) 16, which is subjected to treatment operations 20, such as filtration, tar and sulphur removal, cooling, compression and/or heat recovery.

As is known, gasification of biomass generates a hydrogen lean/deficient synthesis gas, having a H₂:CO molar ratio of about 0.8 to 1.2, which is further treated to a Water-Gas-Shift process (WGS) 30, whereby a least a portion of the CO is converted into CO₂ by reaction with steam 32 to adjust H₂:CO molar ratio to about 2.0 or greater to obtain a hydrogen rich syngas 42 to meet the requirements of the Fischer Troscph (FT) process in a FT reactor 50. An optional CO₂ removal unit 40 is added to adjust the quantity of CO₂ in the final hydrogen rich syngas feed 46 to optimize the performance of the FT unit 50 to obtain FT liquids 52. The raw FT liquids 52 are refined to specification biofuel products, primarily Naphtha 62, Diesel 64 and Wax 66, in the FT Upgrader 60 using typical processing steps such as hydrocracking, isomerization and/or fractionation operations.

Optionally, a hydrogen generation unit 36, such as a Steam Methane Reformer (SMR) is provided with Water-Gas-Shift (WGS) and pressure swing adsorption (PSA) units to produce high purity (greater than 99%) hydrogen to augment the lean bio-syngas to the required H₂:CO molar ratio=2.0 for the FT process.

Additionally, a suitable reformer 70 consisting of a SMR or ATR is used to reform primarily unconverted FT compounds such as CH₄ and CO₂ from the tail-gas stream 56 to produce an additional bio-syngas stream 72 for additional FT liquids 52 production.

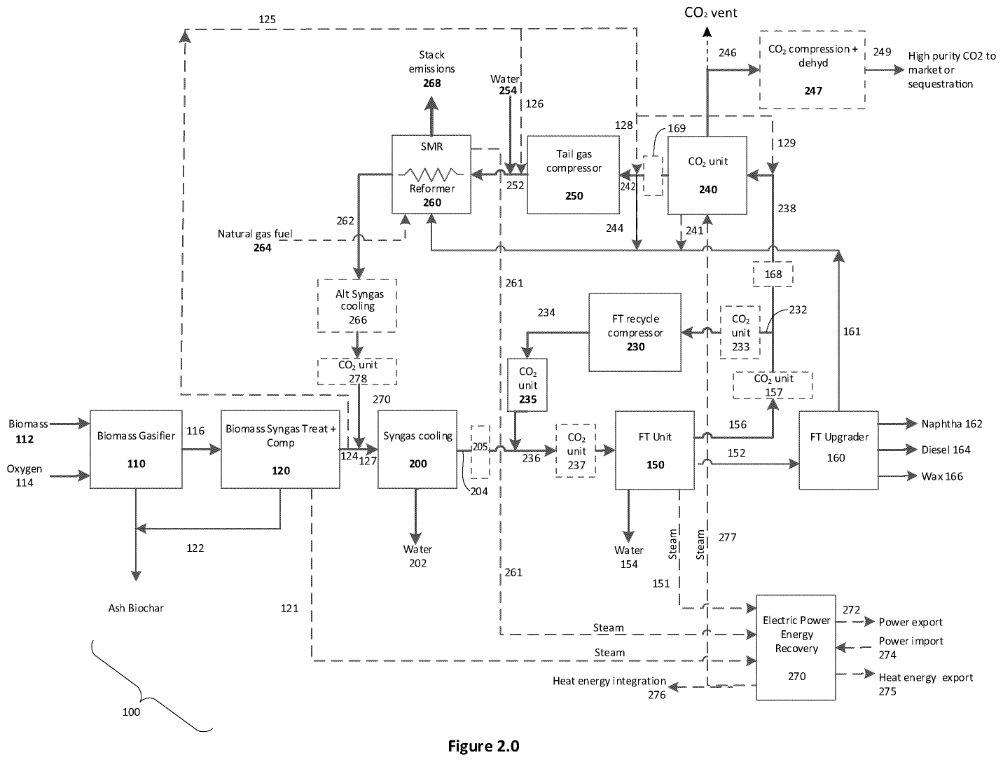

FIG. 2 depicts a flow diagram of an embodiment of the process of the present invention, showing one or more CO₂ removal unit operation(s) for the production of low carbon intensity fossil free bio-synthetic fuel.

The process is generally denoted by numeral 100 and involves treating a biomass feedstock 112 in a gasifier 110 to which an oxidant such as oxygen 114 is added as required to generate a hydrogen lean bio-syngas stream 116, which is subjected to treatment operations 120, such as filtration, tar and sulphur removal, cooling, compression and/or heat recovery to obtain a hydrogen lean syngas feed steam 124. The hydrogen lean syngas feed steam 124 is cooled to form syngas feed stream 204 which is fed to FT reactor 150 to form FT liquid hydrocarbons 152 and FT vapours 156.

The FT vapours 156 are separated from the FT liquids 152, and divided into a FT recycle stream 232 and a tail gas stream 238. The FT recycle stream 232 is compressed to form a high pressure FT recycle stream 234, which is mixed with the syngas feed stream 204 to form a concentrated syngas feed stream 236 to enhance the FT reaction.

The tail gas stream 238 is compressed to form a high pressure tail gas stream 252, which is subjected to a reforming reaction in SMR reforming unit 260 to generate a hydrogen rich syngas gas stream 262. The hydrogen rich syngas 262 is added to the syngas feed steam 124 to form an enhanced syngas feed stream 127. The enhanced syngas feed stream 127 is fed to the FT reactor as feed stream 204, and/or mixed with the FT recycle stream to form the concentrated syngas feed stream 236.

The liquid hydrocarbons are upgraded in FT upgrader 160 to obtain the biofuel(s) naphtha 162, diesel 164 and/or wax 166.

The process further includes strategic incorporation of one or more of CO₂ removal units 157, 233, 235, 237, 240, 278 and 205 to remove excessive CO₂ from different streams generated during the process.

In one embodiment, at least a portion of CO₂, preferably 85 to 100% CO₂ is removed from the tail-gas stream 238 via CO₂ removal unit 240 to obtain a modified/CO₂ depleted tail-gas stream 242. The separated biogenic CO₂ stream 246 is a high purity stream (greater than 99%) ready for carbon utilization or sequestration. The modified tail-gas stream 242 (primarily comprises H₂, CO and CH₄, and reduced amounts of CO₂) is compressed with tail-gas compressor 250 to form a high-pressure tail gas stream 252, which is reformed with water/steam 254 to produce a hydrogen-rich bio-syngas/reformer-syngas stream 262 optimized to maximize the production of fossil-free biofuels.

A minimum purge gas stream 244 is removed from the modified tail-gas stream 242 to control the concentration of undesirable build-up of the inert gases in the FT Unit 150. These inert compounds/gases typically include nitrogen and/or argon, which are present in the biomass gasifier oxidant and the biomass. The purge gas stream 244 is minimized to avoid removal of the valuable compounds such as H₂, CO and CH₄. Higher purge rates results in lower biofuel production. The purge gas stream 244 is combined with low pressure off-gas streams 161 from the FT upgrader 160, and optionally flash gas 241 from the CO₂ unit 240, and used as biogenic fuel for the SMR 260. Natural gas 264 can be added to supplement the energy demand of the SMR 260.

In other embodiments, one or more CO₂ units can be installed in addition to or alternative to CO₂ unit 240. For example, unit 278 is installed to remove CO₂ from hydrogen-rich bio-syngas stream 262; unit 237 is installed to remove CO₂ from the concentrated syngas stream 236; unit 233 is installed to remove CO₂ from the FT recycle stream 232 before compression; unit 235 is installed to remove CO₂ from the compressed FT recycle stream 234; unit 157 is installed to remove CO₂ from the FT vapours 156 prior to being divided into the recycle stream and the tail gas stream, and unit 205 is installed to remove CO₂ from the enhanced syngas feed steam 127 being fed as syngas feed stream 204.

The tail gas stream 238 may contain undesirable concentrations of unstable, unsaturated olefin compounds, when greater than 0.5 mole % (dry basis) that will present performance issues, such as coking of a pre-reformer and/or reforming operation 260. In order to mitigate this problem, the process can further incorporate:
i) adding a olefin saturator unit before the SMR Reformer unit 260,
ii) adding a tailgas cooling unit 168/169 before or after the CO₂ unit 240 to condense and remove the excess olefin compounds,
iii) recycling a portion of the hydrogen lean syngas (about 30%) as feed steam 125 to the high pressure tail gas stream 252 (as stream 126), the modified tailgas stream 242 (stream 128) and/or the tailgas streams 238 (as stream 129), or
iv) a combination of any of the above.

In addition, several process variables can be adjusted to achieve improved overall performance results. These parameters include the adjustments to the FT recycle stream 232, tail-gas stream 238, amount of CO₂ removed 246, amount of purge gas 244, amount of steam 254 (Steam-to Carbon Ratio (S/C Ratio)) and amount of natural gas fuel 264.

Irrespective of these adjustments, the present process produces 100% fossil free biofuel(s) 162, 164 and/or 166.

The recovered high purity biogenic CO₂ stream from the CO₂ unit is available at 10 to 30 psig pressure and only requires incremental compression and dehydration to sequester or to utilize.

The process of the present invention allows for the bio-CO₂ stream 246 to be vented to atmosphere or compressed in unit 247 and sequestered as stream 249. If the bio-CO₂ stream 246 is vented the resulting CI will be less than 40 gCO₂e/MJ but greater than 0 gCO2e/MJ. If the bio-CO₂ stream 246 is sequestered, the resulting CI will be less than 0 gCO2e/MJ, and as low as −40 gCO2e/MJ. The major benefit of this configuration of the current invention is that a significant portion of the CO₂ concentrated and absorbed by the trees from the atmosphere that is not converted as biomass to biofuels, is recovered and sequestered to lower the level of CO₂ in the atmosphere.

In addition, energy, primarily in the form of steam or heat medium, is removed from the biomass gasifier 110 and/or the treatment unit 120 as stream 121, the SMR 260 as stream 261, and FT Unit 150 as stream 151, and integrated to form overall energy 270, which can be used to generate electrical power and used as heat energy 277 for the process units such as the CO₂ unit 240.

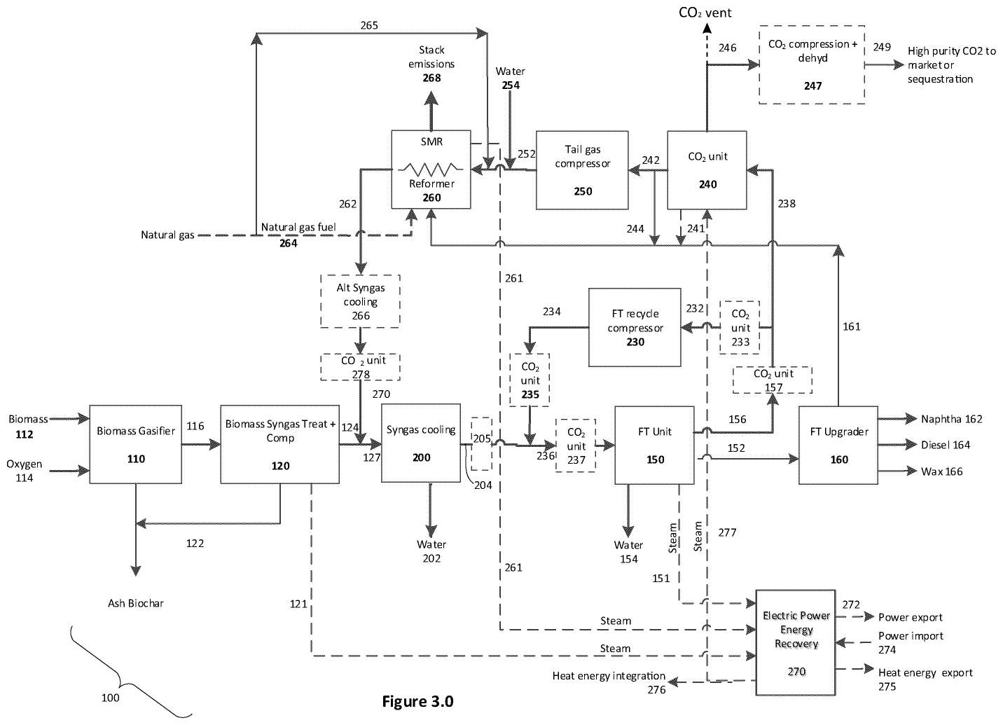

FIG. 3 illustrates a variation of the process of FIG. 2, wherein a portion of natural gas 265 or other suitable hydrocarbon (such as NGL or LPG) is added to the compressed tail gas stream 252 to enrich the syngas 262 for increased feed to the FT Unit 150. This embodiment results in further increased production of synthetic fuels (162, 164 and 166). However, these fuels will be a blend of fossil synfuel and biosynfuel, and may be proportionally segregated to be marketed to separate fossil or bio-based markets.

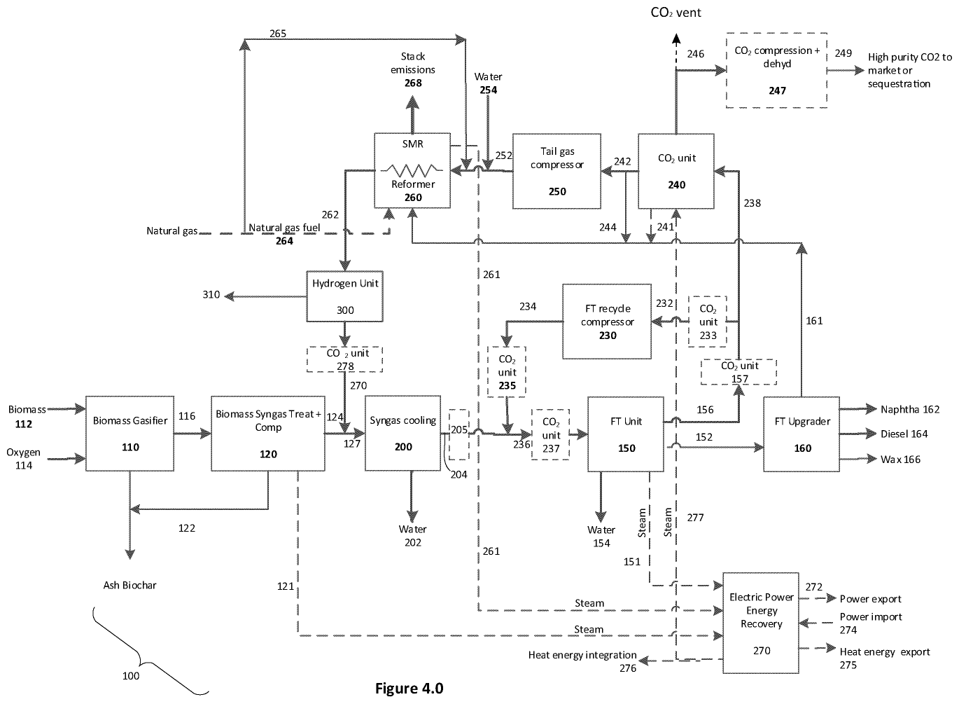

FIG. 4 illustrates a variation of the process of FIG. 3, wherein additional natural 265 is added and the S/C ratio adjusted to treat at least a portion of the hydrogen rich syngas 262 in a hydrogen separation unit 300 to produce a high purity hydrogen stream 310 for external markets and/or for use in the FT Upgrader 160. Non-limiting examples of hydrogen separation unit 310 include membranes, PSA and solvent absorption units.

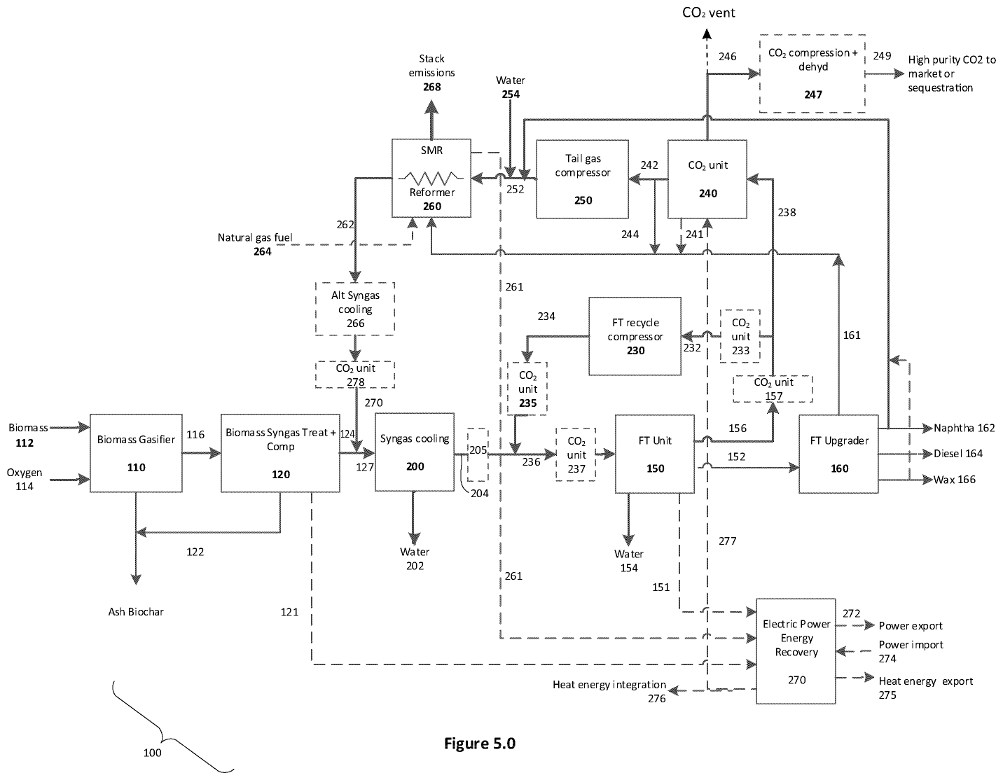

FIG. 5 illustrates a variation of the process of FIG. 2, wherein the biosynthetic naphtha 162 and/or the biosynthetic wax 166 can be recycled to the high-pressure stream 252 as combined feed to the SMR for enhanced production of biofuels. Certain FT processes allow for the minimum production of naphtha 162 and wax 166, and maximum production of synthetic diesel 164. By recycling these lower value streams, the process of the current invention produces only valuable synthetic biodiesel and biojet fuels.

Table 1 illustrates results of computer simulated calculations showing a range of performance data for various process parameters. All cases presented assume that the FT Unit 150 and the biomass gasifier unit 110 are operating at maximum limits, including a fixed FT Recycle stream 232 rate. These calculations indicate that all cases are producing a 100% fossil-free, bio-fuel.

Case 1 illustrates the maximum production of BioFuels (162 and 164). To achieve this result minimal Purge Gas 244 is removed for fuel and the maximum natural gas fuel 264 is used to meet the energy duty of the SMR 260. Significant quantity of BioCO₂ 246 is available for sequestration. Additional duty of SMR 260 using maximum natural gas fuel 264, resulting in additional fossil CO₂ emission from the SMR stack. These calculation indicate, although there will be some impact on the Carbon Intensity (CI=g CO2e/MJ) of the low carbon biofuel, the CI will be less than 40 g CO2e/MJ and greater than 0 g CO2e/MJ.

Case 2 illustrates an optimized production case of BioFuels (162 and 164) which results in maximum BioCO₂ 249 available for sequestration, with moderate SMR Duty, low natural gas feed 264 requirement and low CI impact, expected to be less that 0 to −40 g CO2e/MJ.

Case 3 illustrates the benefits of changing the moisture content (MC %) of the feed biomass 112 to the biomass gasifier 110. Higher moisture content is limited by the biomass gasifier syngas 116 output capability, however results in minimal fossil natural gas fuel 264 usage. This case represents significant reduction of the CI of the fossil-free biofuel expected to be less than 10 g CO2e/MJ.

Case 4 illustrates the total elimination of all the natural gas as fuel 264 to the SMR 260. All fuel used would be biofuel from the purge Gas 244 and off-gas (161 and 241) streams. This Case represents the lowest CI near 0 g CO2e/MJ BioFuel without CO₂ sequestration, and the lowest production of Biofuels (162 and 164).

TABLE 1
LOWEST BIOFUEL

| | Case 1 | | Case 3 | |
|---|---|---|---|---|
| | MAXIMUM BIOFUEL | Case 2 | LOWEST BIOFUEL | Case 4 |
| | PRODUCTION | MAXIMUM | CARBON INTENSITY | 100% BIO PROCESS |
| | MAXIMUM NAT GAS | BIOCO2 for | CI less than 10 g CO2e/MJ | NO FOSSIL NAT |
| | FUEL | SEQUESTRATION | w/o SEQUESTRATION | GAS FUEL |
| ABS DRY Biomass, t/d | 234 | 234 | 208.2 | 202.2 |
| Moisture Content, % | 12 | 12 | 20 | 22 |
| Gasifier O2 Demand, t/d | 72 | 72 | 71 | 71 |
| Biosyngas, MMSCFD - total | 12.3 | 12.3 | 11.7 | 11.5 |
| Process P/L Gas, MMSCFD | 0.0 | 0.0 | 0.0 | 0.0 |
| Fuel P/L Gas, MMSCFD | 1.7 | 0.8 | 0.1 | 0.0 |
| Total P/L Gas, MMSCFD | 1.7 | 0.8 | 0.1 | 0.0 |
| TG Recycle to SMR, MMSCFD | 8.0 | 3.6 | 2.0 | 1.8 |
| Purge Gas to Burner, MMSCFD | 0.5 | 1.1 | 1.1 | 1.1 |
| Bio-CO2 removed from Amine Unit, TPD | 191 | 195 | 182 | 179 |
| Total Off Gas to Burner, MMSCFD | 0.7 | 1.3 | 1.3 | 1.3 |
| Total Off Gas to Bruner, LHV, Btu/Scf | 548.4 | 650.7 | 704.9 | 711.8 |
| SMR Absorbed Duty, MMBtu/h | 45.7 | 35.8 | 22.2 | 19.7 |
| SMR Fire Duty, MMBtu/h | 85.9 | 66.9 | 41.4 | 37.1 |
| Steam to SMR, lb/hr | 10450 | 21400 | 11750 | 8490 |
| S/C - SMR In | 2.7 | 7.0 | 7.0 | 6.1 |
| SMR Outlet Flow, MMSCFD | 25.8 | 23.9 | 14.7 | 12.5 |
| Biosyngas H2:CO | 0.9 | 0.9 | 1.2 | 1.3 |
| H2:CO - SMR Out | 3.9 | 6.5 | 6.7 | 6.2 |
| H2:CO - LFP Reactor Inlet | 2.0 | 2.0 | 2.0 | 2.0 |
| Fresh Syngas to LFP, MMSCFD | 31.2 | 24.0 | 18.8 | 18.0 |
| TG LFP Recycle, MMSCFD | 31.5 | 38.5 | 43.8 | 44.6 |
| LFP Inlet, MMSCFD | 62.6 | 62.5 | 62.6 | 62.5 |
| LFP Inlet H2 + CO, % | 54.6 | 44.7 | 35.0 | 33.0 |
| LFP Liquid, BPD | 578 | 484 | 380 | 362 |
| Diesel Product, BPD (FP 85° F.) | 487 | 401 | 314 | 299 |
| Naphtha Product, BPD | 65 | 61 | 48 | 46 |
| D + N, BPD | 553 | 462 | 362 | 345 |
| Biosyngas Compressor, hp (K-001) @ 80% EFF | 2129 | 2129 | 2022 | 1995 |
| LFP recycle Compressor, hp (K-201) @ | 597.9 | 589.1 | 583.1 | 581.7 |
| 80% EFF | | | | |
| TG Recycle Compressor, hp (K-301) @ 72% EFF | 196.6 | 88.1 | 48.7 | 44.2 |
| CO2 Emission from SMR Stack, t/d | 128 | 103 | 66 | 60 |
| % CO2 from fossil fuel in SMR Stack | 77 | 43 | 7 | 0 |
| CO2 from Fossil Fuel in SMR Stack, t/d | 99 | 44 | 5 | 0 |
| Biomass Carbon Contribution, % - based on | 100 | 100 | 100 | 100 |
| Carbon in | | | | |

The results of the current invention may be optimized with all the process variables to achieve a range of results around the cases as illustrated in Table 1.

Although the invention has been described with reference to certain specific embodiments, various modifications thereof will be apparent to those skilled in the art without departing from the spirit and scope of the invention. All such modifications as would be apparent to one skilled in the art are intended to be included within the scope of the following claims.

1. A process for enhanced production of biofuel(s) from a biomass feedstock, comprising:
a) gasifying a biomass feedstock under partial oxidation reaction conditions to generate hydrogen lean syngas stream comprising H₂, CO, CO₂, CH₄, and inert gases;
b) treating and cooling the hydrogen lean syngas stream to form a syngas feed stream comprising H₂, CO, CO₂, CH₄ and the inert gases, and feeding the syngas feed stream to a Fischer Tropsch (FT) reactor, wherein a portion of H₂ and CO react to produce liquid hydrocarbons and FT vapours, wherein the FT vapours comprise unreacted portion of H₂ and CO in the FT reactor, and non-reactive CO₂, CH₄, and inert gases in the FT reactor;
c) separating the FT vapours from the liquid hydrocarbons;
d) dividing the FT vapours into a FT recycle stream and a tail gas stream;
e) compressing the FT recycle stream to form a high pressure FT recycle stream and mixing same with the syngas feed stream to form a concentrated syngas feed stream to enhance the FT reaction;
f) removing at least a portion of the CO₂ from the tail gas stream to form a modified tail gas stream and removing a purge stream from the modified tail gas stream to circumvent build-up of non-reactive inert gases;
g) compressing the modified tail gas stream to form a high pressure tail gas stream and subjecting the high pressure tail gas stream to steam methane reforming to generate a hydrogen rich reformer-syngas stream and adding same to the syngas feed stream to form an enhanced syngas feed stream, and
h) upgrading the liquid hydrocarbons to obtain the biofuel(s).

2. The process of claim 1, further comprising removing at least a portion of the CO₂ from the FT vapours prior to being divided into the FT recycle stream and the tail gas stream.

3. The process of claim 1, further comprising removing at least a portion of the CO₂ from the FT recycle stream, high pressure FT recycle stream, or both.

4. The process of claim 1, wherein the treating step b) comprises filtration, tar removal, sulphur removal, cooling, compression and/or heat recovery.

5. The process of claim 1, further comprising adding natural gas and/or natural gas liquids to the high pressure tail gas stream directed to the reforming reaction.

6. The process of claim 5, further comprising adding water and/or steam to the high pressure tail gas stream and manipulating steam to carbon ratio to exceed the H₂:CO moral ratio in the syngas gas being fed to the FT reactor.

7. The process of claim 1, further comprising cooling the tail gas stream before or after the CO₂ removal step to remove at least a portion of olefins generated in the FT reactor.

8. The process of claim 1, further comprising recycling at least a portion of the hydrogen lean syngas to the high-pressure tail gas stream, the modified tail-gas stream or the tail gas stream to dilute concentration of olefins in the stream being fed to the reforming reaction.

9. The process of claim 1, wherein the biofuel comprises naphtha and wax, and the process further comprises recycling at least a portion of the naphtha and/or wax to the high pressure tail gas stream directed to the reforming reaction.

10. The process of claim 1, further comprising directing CO₂ removed from the tail gas stream for carbon utilization and/or sequestration.

11. The process of claim 1, wherein the process further comprises using off/refinery-gas generated in the upgrading step as fuel in the reforming reaction.

12. The process of claim 11, further comprising adding the purge stream to the off gas.

13. The process of claim 1, further comprising feeding at least a portion of the hydrogen rich reformer-syngas to a hydrogen separation unit to obtain high purity hydrogen stream.

14. The process of claim 1, further comprising recycling at least a portion of excess heat and/or steam from the biomass gasifier to generate electrical power and/or heat energy.

15. The process of claim 1, further comprising feeding at least a portion of steam generated in step b) to generate electrical power and/or heat energy.

16. The process of claim 1, further comprising feeding at least a portion of steam generated in the reforming reaction in step g) to generate electrical power and/or heat energy.

17. The process of claim 14, wherein the heat energy is used in CO₂ removal.

18. The process of claim 1, wherein the CO₂ is removed via a chemical absorption unit selected from an amine unit, or via a physical absorption unit.

19. The process of claim 1, wherein the process comprises removing CO₂ from:
the FT vapours in the tail gas stream prior to compressing the tail gas stream, to form a CO₂ depleted tail gas stream, and/or
the hydrogen rich reformer-syngas prior to being added to the hydrogen lean syngas stream.
